(19) United States
(12) Patent Application Publication
(10) Pub. No.: US 2010/0157069 A1
(43) Pub. Date: Jun. 24, 2010

(54) IMAGE PRODUCING APPARATUS, IMAGE DISPLAYING METHOD AND RECORDING MEDIUM

(75) Inventor: Katsuya SAKAMAKI, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/640,473

(22) Filed: Dec. 17, 2009

(30) Foreign Application Priority Data
Dec. 24, 2008 (JP) 2008-326730

(51) Int. Cl. H04N 5/225; H04N 5/76; H04N 5/222

(52) U.S. Cl. 348/207.2; 348/231.99; 348/333.01; 348/E05.031; 348/E05.022; 348/E05.024

(57) ABSTRACT

In response to operation of a shutter key (3), a digital camera (1) captures a plurality of successive images each including an image of a subject in accordance with settings, and an image of only a motionless background excluding the subject, using an image capturing unit (8), and then detects changes in pixel between the background image and each of the successively captured images. When the detected pixel changes exceed a threshold, or when the images of the subject in the captured images differ largely, a maximum changing-pixel collection area in each of the captured images different from that in another captured image is determined as an image area to be extracted in the former captured image. Then, the determined image area is extracted from the former captured image (FIG. 3).

### CROSS-REFERENCE TO RELATED APPLICATIONS

This application is based upon and claims the benefit of priority from the prior Japanese Patent Application No. 2008-326730, filed Dec. 24, 2008, the entire contents of which are incorporated herein by reference.

### BACKGROUND OF THE INVENTION

1. Field of the Invention

The present invention relates to an image producing apparatus, image displaying method and recording medium.

2. Description of the Related Art

In the past, a technique for displaying a GIF animations is known, as disclosed by JP 11-298784. In this technique, data on a multi-composite image of successively captured images is stored. When these images are reproduced and displayed, the positions of the respective individual mages are sequentially designated, thereby displaying a GIF animation using these images as frames. Therefore, it does not produce a GIF animation of only particular image areas included in the captured images.

### SUMMARY OF THE INVENTION

It is therefore an object of the present, invention to produce a moving image including as frames only specified image areas of the successively captured images.

In order to achieve the above object, one aspect of the present invention provides an image producing apparatus comprising: an image extractor for extracting each of a plurality of image areas of a common subject from a plurality of successively captured images each including an image of the subject; and a file producer for producing a file which includes that image area extracted by the image extractor.

It is another aspect of the present invention to provide an image displaying method comprising: extracting each of a plurality of image areas of a common subject from a plurality of successively captured images each including a different image of the subject; producing a file which includes that extracted image area; and displaying a moving image including a composite of an image to be displayed and one of the files produced.

Another aspect of the present invention is to provide a software program product embodied in a computer readable medium for causing a computer to function as means for extracting each of a plurality of image areas of a common subject from a plurality of successively captured images each including a different image of the subject; and producing file which includes that extracted image area.

### BRIEF DESCRIPTION OF THE DRAWINGS

The above and other objects, features and advantages of the present invention will become apparent in the following detailed description of the present embodiment thereof when read in conjunction with the accompanying drawings in which:

FIG. 1A is a plan view a digital camera of one embodiment of the present invention.

FIG. 1B is a back view of the camera of FIG. 1A.

FIG. 2 is a schematic of the camera.

FIG. 3 is a flowchart of operation of the camera.

FIG. 4 is a flowchart continued to that of FIG. 3.

FIG. 5 illustrates a display performed by the camera.

FIG. 6 illustrates an exemplary description of a metafile.

### DETAILED DESCRIPTION OF THE PREFERRED EMBODIMENT

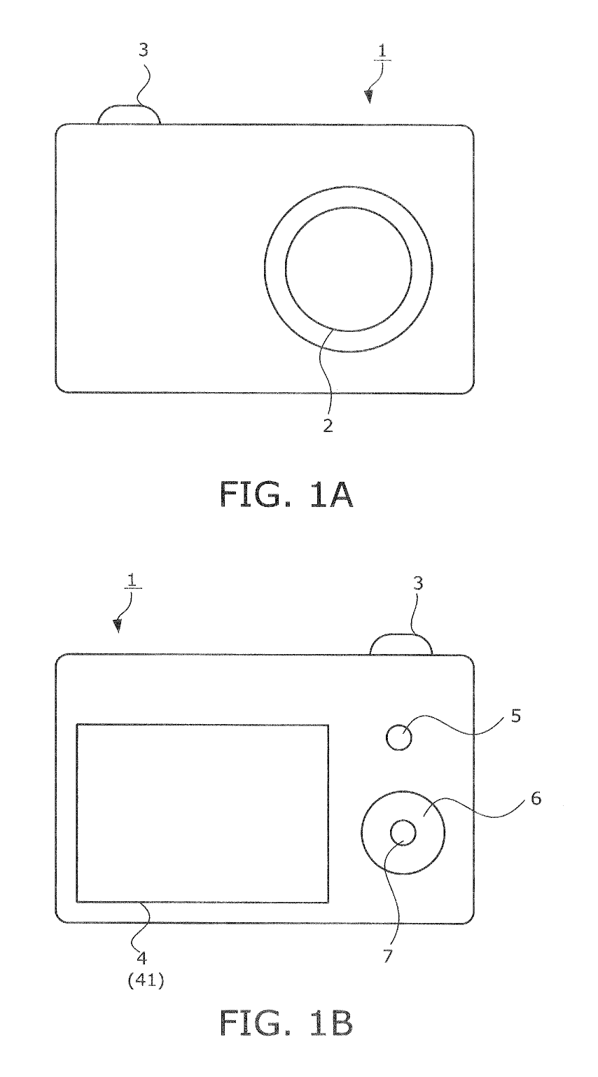

Referring to FIGS. 1A and 1B, an image capturing apparatus as one embodiment of the present invention is shown which includes an image capturing lens 2 on its front and a shutter key 3 of a key-in unit 20 on top thereof. The shutter key 3 has a so-called half shutter function where the key is half/fully depressable.

The camera has on its hack a display including an LCD 4, a function A key 5 and a function B key 7. Depressable cursor keys 6 are disposed around the function B key 7; i.e. to the right and left of, and above and below, the function B key 7. A transparent touch panel 41 is layered on the display 4.

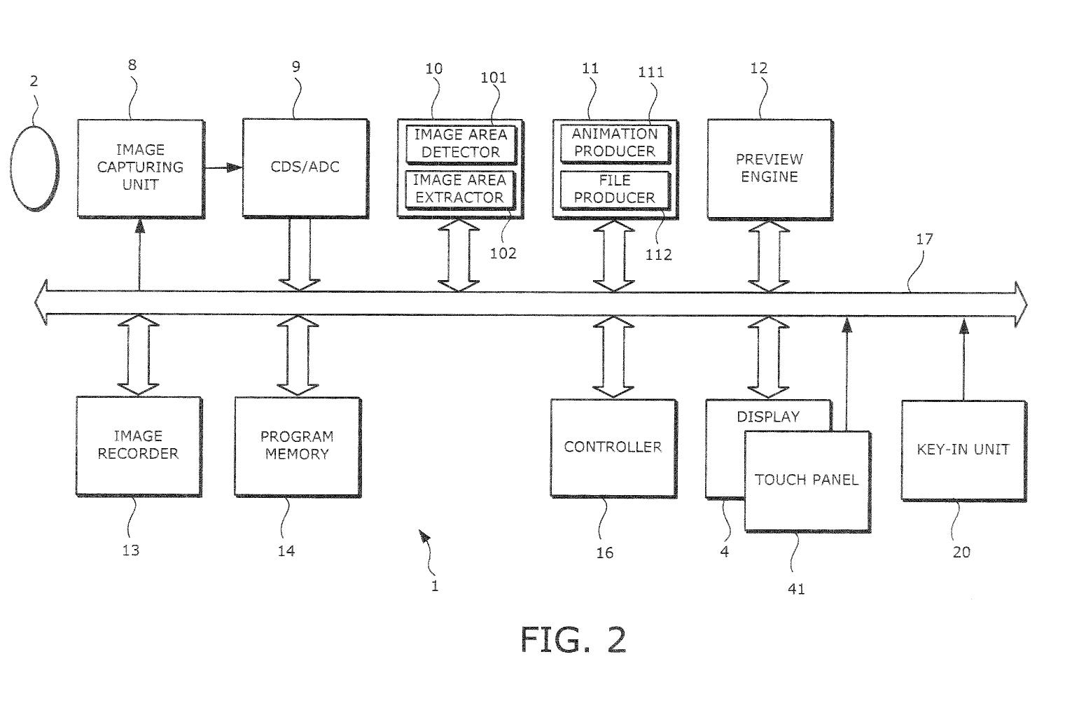

Referring to FIG. 2, the image capturing apparatus 1 includes a controller 16, which is a one-chip microcomputer, connected via a bus line to associated components thereof.

An image capturing unit 8 includes an image sensor such as a CMOS (not shown) disposed on an optical axis of the image capturing lens 2, which includes a focus lens and a zoom lens (both of which are not shown). The image capturing unit 8 is capable of successively capturing images of a subject under control of controller 16.

A unit circuit 9 receives a captured analog image signal corresponding to an optical image of the subject from the image capturing unit 8. The unit circuit 9 includes a CDS which holds a received captured image signal, an automatic gain control (AGC) circuit (not shown) which amplifies the captured image signal, an A/D converter (ADC) which converts the amplified image signal to a digital image signal.

An output signal from the image capturing unit 8 is delivered via the unit circuit 9 as a digital signal to an image processor 10 where the signal is subjected to various image processing processes. Then, a resulting image signal is reduced by a preview engine 12, and displayed as a live view image by the display 4.

In image recording, the signal processed by the image processor 10 is encoded by an encode/decode unit 11 and recorded on the image recorder 13. In image reproduction, the image data read from the image recorder 13 is decoded by the encode/decode unit 11 and then displayed on the display 4.

The image processor 10 includes an image area detector 101 and an image area extractor 102. The image area detector 101 detects a pixel color changing area of each of successively captured images, which include a moving subject (or person) image, as compared to an average color of the area of a changeless background image. The image area extractor 102 extracts each of the image areas detected by the image area detector 101.

The encode/decode processor 11 includes a moving image producer 111 and a file producer 112. The moving image producer 111 produces an extracted or cutout image file from the image area extracted by the extractor 102. The file producer 112 produces a file in which a background image which will be reproduced in a reproduce mode is associated with the file produced by the moving image producer 111.

In addition to the production of the live view image, the preview engine 12 provides control required to display the background image and the animation on the display 4. The key-in unit 20 is composed of the shutter key 3 and the other keys 5-7 of FIG. 1B.

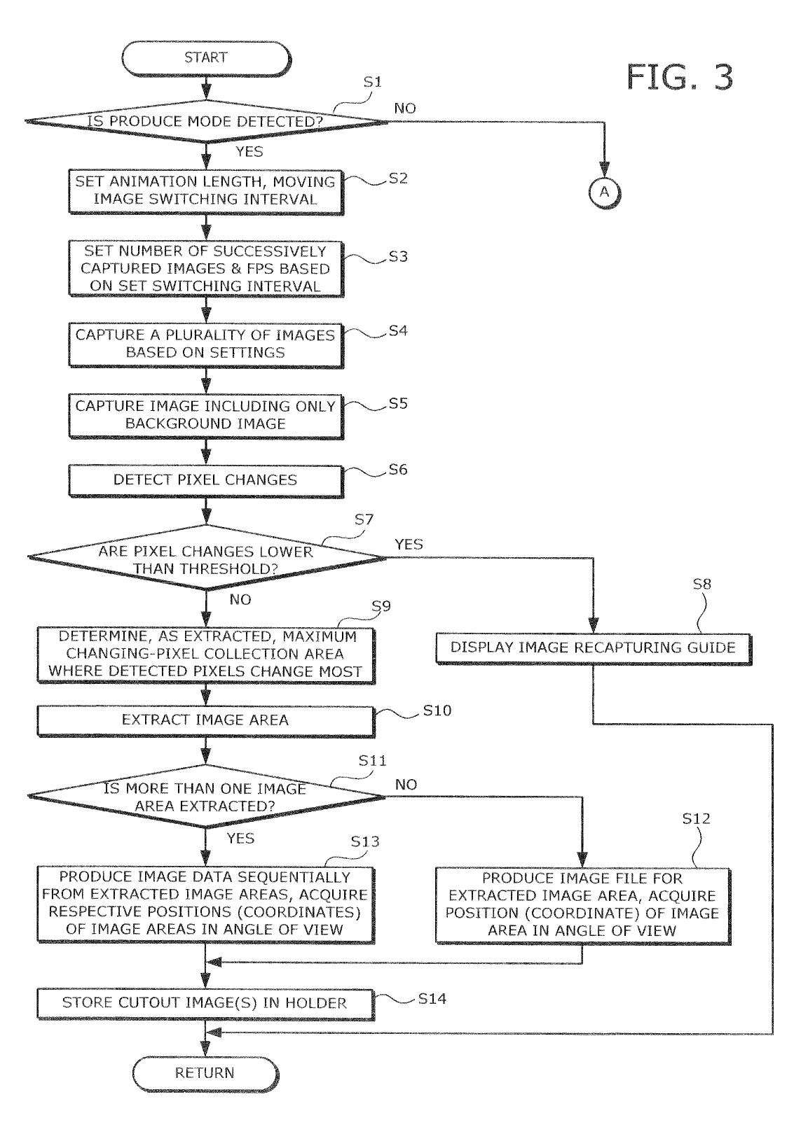

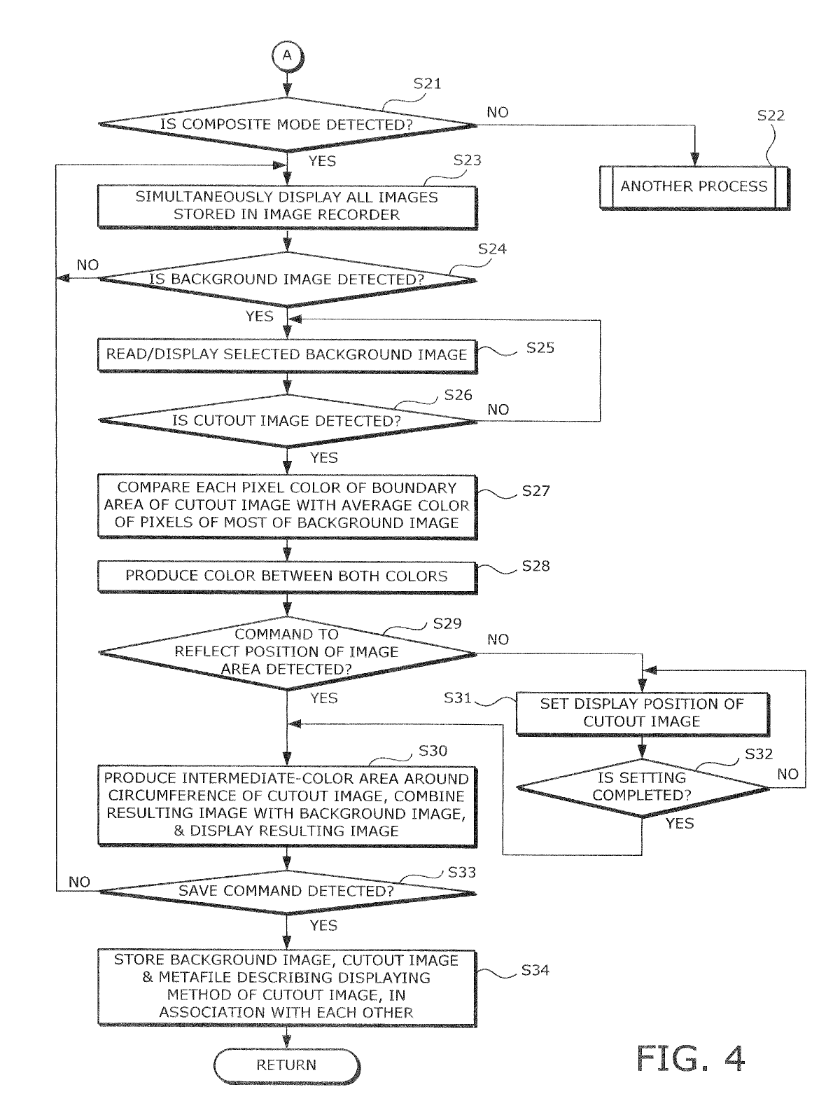

The program memory 14 and the touch panel 41 are connected to a bus line 17. The program memory 14 stores a program to execute a flowchart of FIGS. 3 and 4.

In operation, when the user turns on a power supply (not shown), controller 16 (or control) starts the processing of the flowchart of FIGS. 3 and 4 in accordance with the program stored in the program memory 14.

That is, control determines whether a produce mode is selected (S1); otherwise, control goes to step S12 of FIG. 4, which will be described in more detail later.

If affirmative at step S1, a user sets the length (or reproduction time) of an animation to be produced and a time interval at which one moving image is switched to another (step S2). Then, the number of successively captured images and frames per second (FPS) are automatically set based on the set time interval when the moving image is switched (step S3). For example, when the user desires to produce an animation of a length of one second and 3 frames per second, the number of successively captured images is set to 3 and the FPS to 3 at step S3.

The processing processes of steps S2 and S3 may be eliminated. In this case, a preset number of successively captured images is obtained and a preset FPS is used.

As described above, the number of successively captured images and the FPS are set automatically based on the length or reproduction time of the animation which includes the moving image and the time interval when one moving image is switched to another. Thus, the user is only required to set desired operating conditions of the animation to set the conditions for capturing images successively on the image capturing apparatus.

When the setting is completed at step S3, the content of this setting is stored on a working memory (not shown) of controller 16, and the user's operation of the shutter key 3 is waited.

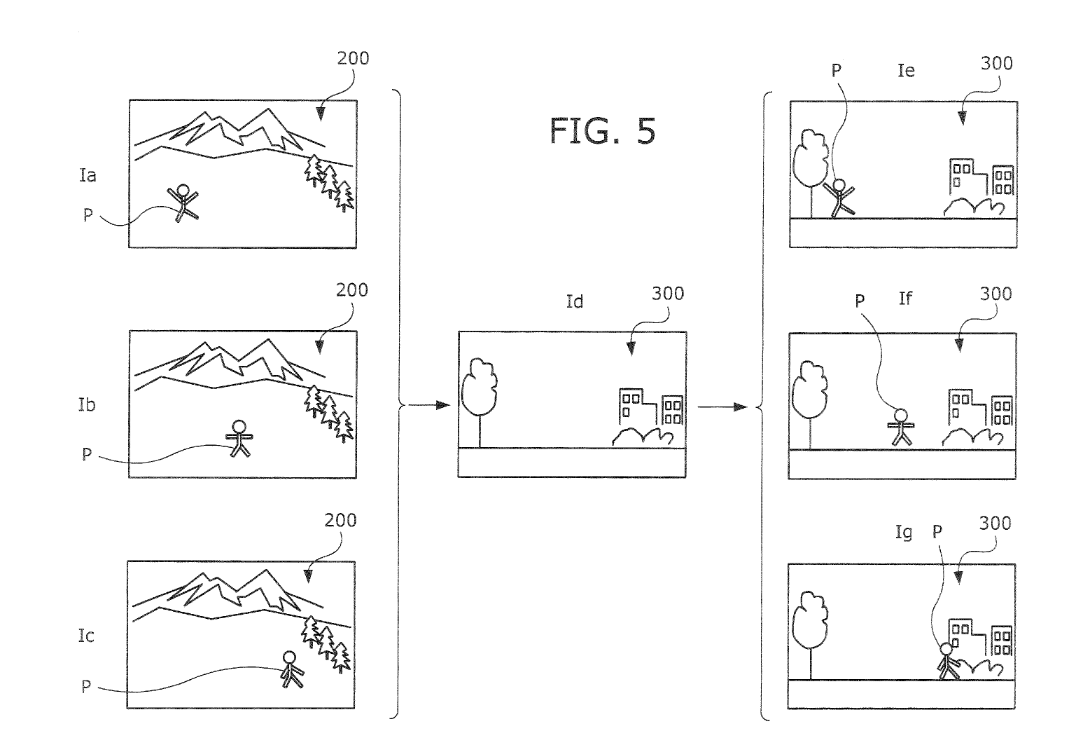

Then, when the shutter key 3 is operated, the image capturing apparatus 8 successively captures the set number of frame images in accordance with the content of the setting (step S4). For example, when the user sets production of a 3-frame/second animation, the image capturing apparatus captures images Ia-Ic of FIG. 5 successively.

Alternatively, to achieve the same object, the image capturing apparatus 8 may fetch and use a plurality of successively captured images recorded already on the image recorder 13.

Then, the image capturing unit 8 captures an image including only the background image without the image of the subject (Step S5) and then detects pixel changes in each of the successively captured images as compared to the background frame image (Step S6).

At this time, the images Ia-Ic of FIG. 5 are successively captured images which cooperate to wholly indicate the image of the subject P moving before a same background image (representing a mountain) 200. Thus, there are no changes in the background, but the position and posture and hence pixels of the image of the subject P change in the angle of view. Therefore, at step S6, only the image area of the subject P of each of the images Ia-Ic is detected as changing pixels or differences.

Subsequently, control determines whether the detected pixel changes are below a threshold (step S7). If affirmative (or otherwise if there are no considerable changes in posture or area between the images of the subject in any two of the successively captured images), a guide message which advises the user to change the background image used so far to another and then recapture images successively is displayed on the display 4 (step S8). Then, control 13 goes to a return point.

If negative at step S7 and the pixel changes exceed the threshold; i.e., if there are large differences in the area of the image in each of the successively captured images of the subject in any two successively captured images, control goes to step S9 to determine a maximum changing-pixel collection area, in each of the successively captured images where the detected pixels change most, as the whole image area of the moving subject to be extracted.

For example, in the images Ia-Ic of FIG. 5, there are no changes in the background 200, but pixel changes in the image of the subject P exceed the threshold, and the maximum changing-pixel collection area where the pixels change most is the whole image area of the subject P. Thus, the whole image area of the subject P is determined as extracted.

Then, a process for extracting the determined image area from each of the successively captured mages is performed (step S10). Thus, in the present embodiment, each whole image area of the moving subject P is extracted from a respective one of the images Ia-Ic.

Then, control determines whether a plurality of image areas is extracted (step S11). If negative or only one image area is extracted, an image file of a predetermined file format is produced which includes only that image area and its position or coordinate in the angle of view are acquired (step S12).

As in this example, when a plurality of image areas of the subject P extracted or cut out from the associated plurality of successively captured images, image data are produced sequentially from those of areas of the subject P, and then the positions or coordinates of the respective image areas of the subject P in the same angle of view are acquired (step S13).

After step S12 or S13, the file produced at step S12 or S13 is stored along with the corresponding acquired position or coordinate of the image area in a holder provided beforehand on the image recorder 13 (step S14). Then, control 13 goes to the return point.

While the image file produced at step S12 or S13 includes single image data of α-channel information where the image area of the subject P has a 0% transparency and the remaining (or background) image area has a 100% transparency, or a collection of such image data, the present invention is not limited to these examples.

For example, if the image data includes single image data, it may correspond to a file of a transparent PNG or GIF format. When the image data includes a plurality image data, it may be a collection of image data corresponding to the transparent PNG or GIF format or image data including an animation image corresponding to the transparent GIF format.

When the selection of the produce mode is not detected in the determination at step S1, control goes to step S21 of FIG. 4 where control determines whether a composite mode is selected. If negative, control goes to another process (step S22). When the selection of the composite mode is detected, the images captured and prestored on the image recorder 13 are displayed simultaneously on the display 4 (step S23).

Control then determines whether any of the simultaneously displayed images is selected as a background image based on a signal from the touch panel 41 by touching the touch panel 41 (step S24).

If affirmative, control reads the background image from the image recorder 13 and display it on the display 4 (step S25). For example, by the processing at step S25, an image Id including an image, of a town 300 as shown in FIG. 5 is displayed as the background image on the display 4.

Then, control determines whether any of the cutout images extracted and stored at steps S10-S14 has been detected (step S26). More particularly, in this case, the display 4 is temporarily switched so as to simultaneously display thereon the files each including the cutout image stored at step S14. Control then determines based on a signal from the touch panel 41 whether any one of the files displayed simultaneously is selected by touching the touch panel 41.

If affirmative, control compares respective colors of boundary pixels of the cutout image of the selected file adjacent to the transparent area with an average color of the pixels of most of the background image (step S27).

For example, assume that a plurality of files each containing only the image area of the whole body of the subject P of a respective one of the images Ia-Ic shown in FIG. 5 is selected. Then, control detects respective pixel colors of a boundary area of the image of the subject P adjacent to the transparent area. Also, assume that the image Id of FIG. 5 is selected as the background image.

Then, control detects an average color of the pixels of most of the background image (representing the town) 300 of the image Id. Control then compares each detected pixel color of the boundary area of the image of the detected subject P with the average color of the pixels of most of the background image 300.

Then, an intermediate color between the average color of the background image and the color of each of the boundary area pixels is produced based on a result of the comparison at step S27 (step S28). Control then determines whether a command to reflect the position (or coordinate) of the cutout image stored in the folder at step S14 in the background image to be combined with the cutout image has been detected (step S29).

If affirmative, an area of the intermediate color produced at step S28 and having a predetermined width is produced around the circumference of the selected cutout image and a resulting image is combined with the selected background image. Then, a resulting image is displayed (step S30).

That is, assume that an animation file including the images of the subject P of the images laic of FIG. 5 as the cutout images is selected; that the image Id including the background image 300 is selected as the background image; and that the command to reflect the position (or coordinate) of the image area is detected.

Then, the pixel colors of the area of the predetermined width around the outer periphery of each of the images of the subject P are changed to the respective intermediate colors produced at step S28.

Then, each of the images of the subject P with its intermediate-colored peripheral area of the predetermined width is combined with a respective background image Id at the same position as the image of the subject P in a respective one of the images Ia-Ic.

Thus, as shown in FIG. 5, by the processing at step S30, the display 4 displays a moving image of images Ie, If and Ig where the images of the subject P at the respective positions in the images Ia, Ib and Ic each are combined with the background image (representing the town) 300 at the same positions as in the images Ia, Ib and Ic and not with the background image 200.

Thus, according to this embodiment, a moving image of frames where sequentially slightly different specified image areas each are combined with any selected same image is produced so as to allow the user to enjoy the moving image.

Each of the pixels of the boundary area of the image of the subject P is displayed in a color between the original color of that pixel and the average color of the pixels of the background 300. Thus, a natural moving image is reproduced and displayed in which a respective one of the sequentially slightly different images of the subject P is combined integrally with the background image 300.

Since in the embodiment the images of the subject P are cut out from the successively captured images, each frame of the moving image may include a specified image area contained in a respective one of the captured images.

When no command to reflect the position or coordinate of the image area is detected at step S29, control sets the position of the cutout image (step S31). That is, control sets, as a display position of the cutout image, a position designated by the user on the touch panel or a position designated randomly by controller 16.

Control then determines whether setting of the display position is completed (step S32). If affirmative, control performs the processing at step S30. Thus, in this case, a moving image of frames in each of which a different image of the subject P is combined at a random position; which is different from each of the positions of the image Ie-Ig of FIG. 5, with the background image is displayed on the display 4.

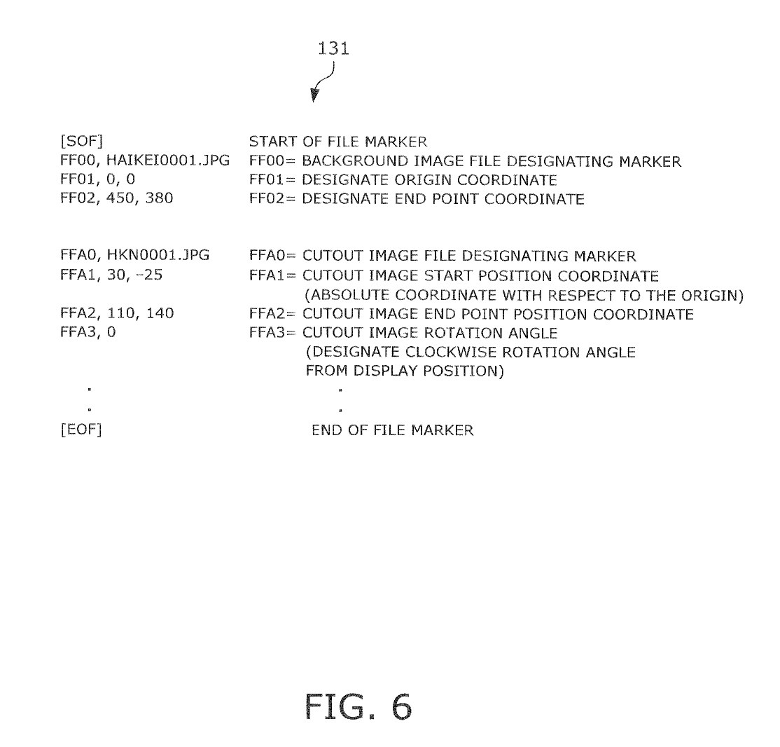

Then, control determines whether a same command is detected (step S33). If negative, control returns to step S23. If affirmative, control stores the background image, the cutout image, and a metafile describing a method of displaying the cutout image, in association with each other on the image recorder 13 (step S34). The metafile is illustrated, for example, by 131 in FIG. 6.

Thus, by reading the metafile 131 later and issuing a reproduce command, a moving image of frames each containing only a different specified image area is produced to arrow the user to enjoy the moving image as required.

While at step S34 the background image, cutout image and the metafile describing the method of displaying the cutout image are illustrated as stored, a plurality of image files each including a composite of a different cutout image and the background image may be stored in association with each other. By doing this, even devices operating in a software environment which cannot decode the metafile can reproduce the composite moving image.

While in the embodiment the image area to be extracted is illustrated as automatically determined at step S9, arrangement may be such that the user can freely designate an image area to be extracted by touching the touch panel 41. By doing so, a moving image of frames each including only any image area designated by the user is produced.

While in the embodiment the image recorder 13 is illustrated as storing the metafile 131 of FIG. 6 in association with the corresponding background image and cutout image, arrangement may be such that the background image file may has the function of the metafile 131 by writing data of the metafile 131 to an Exif header of the background image file.

Alternatively; a file format proposed by the applicant (see JP 2008-091268) may be used to store the background image data and the cutout image data in the same file.

The present invention is applicable to mobile phones with the image capturing and/or reproducing functions, personal computers with a camera, and any other devices having an image reproducing function, in addition to the image capturing apparatus.

Various modifications and changes may be made thereunto without departing from the broad spirit and scope of this invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

What is claimed is:

1. An image producing apparatus comprising:
an image extractor for extracting each of a plurality of image areas of a common subject from a plurality of successively captured images each including an image of the subject; and
a file producer for producing a file which includes that image area extracted by the image extractor.

2. The image producing apparatus of claim 1, further comprising:
a display unit; and
a controller for controlling the display unit so as to display a moving image including a composite of an image to be displayed and one of the files produced by the file producer.

3. The image producing apparatus of claim 2, further comprising:
storage means for storing each of the files produced by the file producer in correspondence to the image to be displayed.

4. The image producing apparatus of claim 3, wherein the storage means further stores a position in the image to be displayed, where each of the extracted image areas is combined with the image to be displayed, in correspondence to the image to be displayed and that file produced by the file producer.

5. The image producing apparatus of claim 1, further comprising:
means for designating an image area of the subject to be extracted by the extracting means.

6. The image producing apparatus of claim 1, further comprising:
an image capturing unit; and
means for detecting changes between a motionless image and each of images captured successively by the image capturing unit, and wherein:
the image extractor extracts an image area of the subject from the associated captured image based on the changes detected by the detecting means.

7. An image displaying method comprising:
extracting each of a plurality of image areas of a common subject from a plurality of successively captured images each including a different image of the subject;
producing a file which includes that extracted image area; and
displaying a moving image including a composite of an image to be displayed and one of the files produced.

8. A software program product embodied in a computer readable medium for causing a computer to function as:
means for extracting each of a plurality of image areas of a common subject from a plurality of successively captured images each including a different image of the subject; and
producing a file which includes that extracted image area.
